(19) United States
(12) Patent Application Publication
(10) Pub. No.: US 2025/0289009 A1
(43) Pub. Date: Sep. 18, 2025

(54) Jet-forming attachment for mounting on a water tap

(71) Applicant: Jürgen OPPEL, Ansbach (DE)

(72) Inventor: Jürgen OPPEL, Ansbach (DE)

(21) Appl. No.: 19/078,837

(22) Filed: Mar. 13, 2025

(30) Foreign Application Priority Data
Mar. 13, 2024 (DE) 10 2024 202 364.7

(51) Int. Cl. B05B 1/10; E03C 1/04

(52) U.S. Cl. CPC B05B 1/10; E03C 1/0404

(57) ABSTRACT

A jet-forming attachment (5) is used for mounting on a water tap (1) and comprises a base body (6) with a mounting opening (7) for mounting on the water tap (1) and with a water channel (13) which has a water inlet opening (11), with which the water channel (13) can be coupled to a water outlet (4) of the water tap (1), and a water outlet nozzle opening (12) which is fluidically connected to the water inlet opening (11) and has an outlet cross-sectional area (A_{D}) which is smaller than an inlet cross-sectional area (A_{E}) of the water inlet opening (11).

The content of German patent application DE 10 2024 202 364.7 is incorporated herein by reference.

The invention relates to a jet-forming attachment for mounting on a water tap.

The available water pressure is often not sufficient for cleaning objects under a water jet output by a water tap. Cleaning aids, such as e.g. brushes, are expensive and restrict the accessibility of the area to be cleaned. Cleaning by hand poses a risk of injury particularly in the presence of sharp-edged objects, such as razor blades or knives.

Attachments for mounting on a water tap are known from CH 263 598 A, DE 1 726 086 U, US 4 838 949 A, CH 362 376 A, DE 10 2017 101 013 A1, DE 1 769 394 U, DE 1 845 797 U, DE 10 2009 060 433 A1, US 5 868 325 A, DE 20 2006 004 971 U1, US 4 941 492 A, US 2009/0 114 745 A1 and DE 85 13 518 U1.

The object of the present invention is to improve the cleaning by means of water from a water tap.

In accordance with the invention, this object is achieved by a jet-forming attachment having the features of claim 1.

The core of the invention is that a jet-forming attachment can be mounted on a water tap, wherein a base body of the jet-forming attachment has a water outlet nozzle opening with an outlet cross-sectional area which is smaller than an inlet cross-sectional area of a water inlet opening of the base body. The pressure with which the water is output from the jet-forming attachment is increased. It is possible to remove stubborn dirt from objects by means of the generated water jet. Water consumption is reduced by reason of the reduced outlet cross-sectional area. Targeted cleaning of the objects is possible by reason of the reduced outlet cross-sectional area. The water jet can be used to clean the objects substantially with pinpoint accuracy.

Tests have shown that by means of the jet-forming attachment in accordance with the invention it is possible in an advantageous manner to clean in particular razor blades with a thin water jet of increased water pressure and in particular also fingernails, jewellery, brushes, frames, sieves and shoes.

The base body can be coupled to the water inlet opening at a water outlet of the water tap. Water which is output from the water outlet of the water tap passes directly into the water inlet opening. The water inlet opening and the water outlet nozzle opening are fluidically connected to one another via a water channel. In particular, the water channel is completely integrated within the base body. The jet-forming attachment is used for direct mounting on the water tap. The jet-forming attachment is easy to handle.

The jet-forming attachment simplifies the mounting on the water tap. By virtue of the fact that the base body has an elastic material, it can be easily attached to the water tap. In particular, the base body is held reliably on the water tap, in particular by reason of the elastic restoring forces. The base body comprises a rubber material.

The jet-forming attachment, in which the base body has a passage opening, can be handled in a flexible manner. In particular, it is possible to position the base body along the water tap, in particular independently of the position of the water outlet on the water tap. The jet-forming attachment can be easily slid onto the water tap. The water tap can penetrate the jet-forming attachment completely and in particular can protrude at the passage opening on the base body.

A transverse channel delimited by the mounting opening and the passage opening has a transverse axis which is oriented transversely, in particular perpendicularly, to a longitudinal axis of the water channel. The longitudinal axis of the water channel is in particular parallel to a surface normal of the water inlet opening.

A jet-forming attachment as claimed in claim 2 simplifies the sealing of the base body on the water tap. In particular, silicone is arranged on at least one and in particular on all inner surfaces of the base body. In particular, all inner surfaces of the base body have a silicone-containing surface. In particular, all inner surfaces of the base body are formed having a silicone coating. In particular, the water channel, the water inlet opening, the water outlet opening, the mounting opening and/or the passage opening are formed having a silicone coating on their inner surfaces.

A jet-forming attachment as claimed in claim 3 has sufficient stability. The base body is formed having increased stiffness.

The design of a jet-forming attachment having a base body as claimed in claims 2 and 3 is particularly advantageous. Such a base body can be designed in particular as a two-component injection-moulded part. The base body is formed substantially of a rubber material with a corresponding hardness value. The base body is stable. In order to ensure advantageous sealing between the base body and the water tap, the corresponding inner surfaces of the base body are formed having a silicone coating. Such a two-component injection moulding method can be performed at a pressure of at least 500 bar and a temperature of at least 200° C. Such a jet-forming attachment is intrinsically stable. A reinforcing element which is possible on the water outlet nozzle opening can be omitted.

A jet-forming attachment as claimed in claim 4 permits an advantageous pressure increase. In particular, the outlet cross-sectional area is between 0.5 m² and 3.2 mm², in particular between 1.0 mm² and 2.5 mm². In particular, the inlet cross-sectional area is 250 mm² to 500 mm², in particular between 300 mm² and 400 mm². In particular, the outlet cross-sectional area and/or the inlet cross-sectional area are round. A diameter of the outlet cross-sectional area is in particular between 0.8 mm and 2.0 mm. A diameter of the inlet cross-sectional area is in particular between 18 mm and 25 mm. In particular, the inlet cross-sectional area can be coupled to commercially available water tap screens. In particular, the ratio of the outlet cross-sectional area to the inlet cross-sectional area is at most 0.05, in particular 0.01, in particular at most 0.005 and in particular at most 0.001.

An outlet cross-sectional area as claimed in claim 5 permits a geometry of the base body which is adapted to stresses. Alternatively, the outlet cross-sectional area can also be rectangular and/or slot-shaped. It is possible to form a cross-sectional area of a water jet to be generated. Different jet geometries can be advantageous in dependence upon the cleaning task.

A jet-forming attachment as claimed in claim 6 is particularly robust. The risk of the base body failing mechanically in the region of the water outlet nozzle opening, in particular the risk of it breaking, is reduced. A reinforcing element is in particular an O-ring but it can also be formed by other geometric elements.

A jet-forming attachment as claimed in claim 7 is designed in an advantageous manner. In particular, the mechanical connection between the reinforcing element and the base body is improved. In particular, the reinforcing element is embedded in the base body and in particular is integrally bonded thereto. For example, the reinforcing element can be embedded in the base body by means of a two-component casting method. The reinforcing element can be produced from a synthetic material, in particular a rubber material, or from a metallic material.

Alternatively, it is feasible for the reinforcing clement to be mounted separately and in particular on an outer periphery of the base body in the region of the water outlet nozzle opening. In order to mount the reinforcing element on the base body, geometric forming elements such as depressions, in particular a circumferential outer groove, can be present on the base body. The reinforcing element acts in particular as an outer peripheral reinforcement.

The production of the jet-forming attachment as claimed in claim 8 is uncomplicated. Handling the one-piece base body is also uncomplicated. The jet-forming attachment can be fitted indirectly onto the water tap.

Alternatively, it is feasible for the base body to be formed of multiple parts, in particular having an upper part and a lower part which are each attached onto the water tap from opposite sides like half shells and are connected to one another, in particular by clipping and/or latching. In this case, the base body can be produced from a material which has comparatively little elasticity and in particular is rigid, such as a metal or a thermoplastic synthetic material. It is advantageous if the base body is produced at least in certain regions from a material which is elastic and in particular liquid-sealing. In particular, rubber and/or silicone is used for this purpose. In particular, the base body in the region of the water inlet opening is formed from an elastic and/or liquid-tight material. An advantageous, in particular sealing mounting of the jet-forming attachment on the water outlet is improved. The elastic material can be surrounded by, and in particular embedded in, a less elastic, in particular rigid material.

A jet-forming attachment as claimed in claim 10 permits advantageous water guidance within the base body. The pressure increase of the water within the base body is effected in particular in a continuous manner.

In particular, the water jet output from the jet-forming attachment is uninterrupted.

A jet-forming attachment as claimed in claim 11 permits an improved fit on the water tap, in particular on the water outlet. In particular, the base body lies with a recess in a sealing manner against the water outlet. In particular, the inner contour of the recess corresponds to the outer contour of the water outlet. The base body is attached with the elastically widened recess onto the water outlet. Water is prevented from coming out inadvertently, in particular between the water outlet and the base body. The jet-forming attachment can be used in a fail-safe manner.

A jet-forming attachment as claimed in claim 12 permits self-clamping, in particular sealing, holding on the water outlet. The risk of water coming out inadvertently at the base body, in particular through the mounting opening, is reduced. In particular, it is possible to mount additional sealing elements on the base body, in particular in the form of inner O-rings which seal the mounting opening, the water inlet opening and, where appropriate, the passage opening on the water tap.

Both the features stated in the claims and the features stated in the following exemplified embodiment of a jet-forming attachment in accordance with the invention are each suitable, either individually or in combination with one another, for developing the subject matter in accordance with the invention. The respective combinations of features do not constitute any restriction with regard to the developments of the subject matter of the invention, but instead have essentially merely exemplary character.

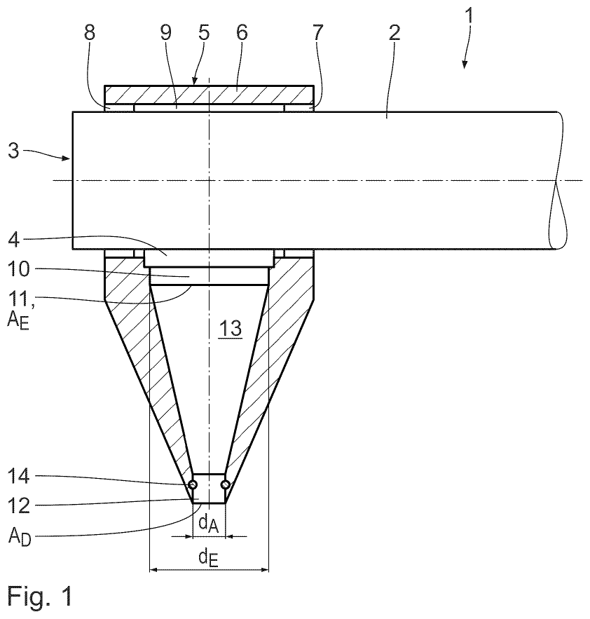

Further features, advantages and details of the invention will be apparent from the description hereinafter of an exemplified embodiment with reference to the drawing. In the drawing:
FIG. 1 shows a schematised sectional view of a water tap comprising a jet-forming attachment, which is mounted thereon, in accordance with the invention.

A water tap 1 illustrated purely schematically in FIG. 1 has a cross tube 2 which, in the region of its free end 3, has a water outlet 4 which is oriented transversely to the cross tube 2. The water outlet 4 is designed in particular as a cylindrical attachment and is screwed into an internal thread on the cross tube 2. In particular, the water outlet 4 is designed as a so-called jet regulator. Water comes out of the water tap 1 at the water outlet 4.

A jet-forming attachment 5 is mounted on the water tap 1. The jet-forming attachment 5 has a base body 6 which, according to the exemplified embodiment shown, is produced in one piece from an elastic material, e.g. rubber and/or silicone.

The base body 6 has a mounting opening 7, with which the base body 6 is attached onto the water tap 1, in particular onto the cross tube 2. A passage opening 8 is arranged on the base body 6 opposite the mounting opening 7 and in particular is oriented concentrically thereto. The cross tube 2 of the water tap 1 can pass with its free end 3 on the base body 6 through the passage opening 8. The water tap 1 protrudes with its cross tube 2 at the base body 6. The mounting opening 7 and the passage opening 8 delimit a transverse channel 9 in the base body 6. The transverse channel 9 serves to receive the cross tube 2.

The base body 6 has a recess 10 which faces towards the water outlet 4. In particular, the base body 6 is arranged on the water tap 1 in such a way that the outlet 4 is arranged at least partially within the recess 10. At the bottom of the recess 10, a water inlet opening 11 is formed with an inlet cross-sectional area A_{E}. According to the exemplified embodiment shown, the water inlet opening 11 is circular with a diameter d_{E}. In particular, the diameter d_{E} is smaller than the outer diameter of the water outlet which is 24 mm according to the exemplified embodiment shown. The base body 6 is sealingly mounted on the water outlet 4 with the recess 10. For this purpose, the elastic material of the base body 6 can be pressed in sections onto the water outlet 4.

In the event that the base body 6 is produced from a rigid material, a sealing holding arrangement is possible in particular by virtue of the fact that at least one additional sealing element, in particular a sealing ring, is arranged in the region of the recess and is arranged in particular between the base body 6 and the water outlet 4.

A water outlet nozzle opening 12 is fluidically connected to the water inlet opening 11 via a water channel 13. According to the exemplified embodiment shown, the water channel 13 is frustoconical in shape. The water channel 13 is tapered, in particular conically tapered, in the direction of the water outlet nozzle opening 12. The water outlet nozzle opening 12 is circular having an outlet cross-sectional area A_{D}. The outlet cross-sectional area A_{D} is smaller than the inlet cross-sectional area A_{E}.

A reinforcing element 14 is arranged on the water outlet nozzle opening 12. In the exemplified embodiment shown, the reinforcing element 14 is designed as an O-ring which is integrated, in particular embedded, into the base body 6. The O-ring can be formed from a metallic material. It is also feasible for the base body 6 to have, in the region of the water outlet nozzle opening 12, an inner groove, into which the reinforcing element 14 is inserted. Alternatively, it is also feasible to arrange the reinforcing element 14 on an outer side of the base body 6, in particular in an outer groove. In this case, the reinforcing element 14 forms a peripheral reinforcement.

According to the exemplified embodiment shown, the water outlet nozzle opening 12 has a diameter d_{A} of 8 mm. It is understood that the geometry of the water outlet nozzle opening 12 can also be non-round and formed with a deviating outlet cross-sectional area A_{D}.

1. A jet-forming attachment for mounting on a water tap, comprising a base body with a mounting opening for mounting on the water tap and with a water channel which has a water inlet opening, with which the water channel can be coupled to a water outlet of the water tap, and a water outlet nozzle opening which is fluidically connected to the water inlet opening and has an outlet cross-sectional area (A_{D}) which is smaller than an inlet cross-sectional area (A_{E}) of the water inlet opening, wherein
the base body has a rubber material, and in that the base body has a passage opening, wherein the mounting opening and the passage opening delimit a transverse channel in the base body, wherein the transverse channel serves to receive a cross tube of the water tap.

2. The jet-forming attachment as claimed in claim 1, wherein the base body has silicone material, in particular a silicone coating, on at least an inner surface, in particular on the water inlet opening.

3. The jet-forming attachment as claimed in claim 1, wherein the elastic material has a hardness of 60 Shore A to 100 Shore A, in particular of 70 Shore A to 95 Shore A and in particular of 80 Shore A to 90 Shore A.

4. The jet-forming attachment as claimed in claim 1, wherein A_{D}/A_{E}≤0.2, in particular A_{D}/A_{E}≤0.05 and in particular A_{D}/A_{E}≤0.01.

5. The jet-forming attachment as claimed in claim 1, wherein the outlet cross-sectional area (A_{D}) has a circular inner contour.

6. The jet-forming attachment as claimed in claim 1, further comprising a reinforcing element which is arranged on the water outlet nozzle opening.

7. The jet-forming attachment as claimed in claim 6, wherein the reinforcing element is integrated in the base body.

8. The jet-forming attachment as claimed in claim 1, wherein the base body is formed in one piece.

9. The jet-forming attachment as claimed in claim 1, wherein the passage opening is arranged concentrically to the mounting opening on the base body.

10. The jet-forming attachment as claimed in claim 1, wherein the water channel is tapered, in particular conically, in the direction of the water outlet nozzle opening.

11. The jet-forming attachment as claimed in claim 1, wherein the water inlet opening is formed at the base of a recess, with which the base body can be mounted on the water outlet, in particular in a sealing manner.

12. The jet-forming attachment as claimed in claim 11, wherein the recess has an inner diameter (d_{E}) which is less than 24 mm.
